(19) United States
(12) Patent Application Publication
(10) Pub. No.: US 2020/0003303 A1
(43) Pub. Date: Jan. 2, 2020

(54) Hydrostatic Traction Drive with a Pressure Cutoff and Method for Calibrating the Pressure Cutoff

(71) Applicant: Robert Bosch GmbH, Stuttgart (DE)

(72) Inventors: Franz Werner, Langenau (DE); Matthias Mueller, Langenau (DE); Michael Frasch, Ulm (DE); Ronny Herrmann, Neu-Ulm (DE); Ulrich Lenzgeiger, Dinkelscherben (DE)

(21) Appl. No.: 16/453,558

(22) Filed: Jun. 26, 2019

(30) Foreign Application Priority Data
Jun. 29, 2018 (DE) 10 2018 210 720.3

(51) Int. Cl. F16H 61/433; F16H 61/00; F16H 39/00; F16H 61/4017

(52) U.S. Cl. CPC F16H 61/433; F16H 61/0021; F16H 2342/10; F16H 61/4017; F16H 2039/005; F16H 39/00

(57) ABSTRACT

A hydrostatic traction drive includes a hydraulic pump for supplying pressure medium to a hydraulic motor of the traction drive. The hydraulic pump has an actuation cylinder with at least one cylinder space and a swept volume which can be adjusted thereby. At least one electrically actuable pressure valve is provided, by means of which an actuation pressure which has an adjusting effect can be applied to the cylinder space. In addition, the traction drive has a device by means of which a pressure of the hydraulic pump can be limited by influencing the actuation pressure.

This application claims priority under 35 U.S.C. § 119 to application no. DE 10 2018 210 720.3, filed on Jun. 29, 2018 in Germany, the disclosure of which is incorporated herein by reference in its entirety.

### TECHNICAL FIELD

The disclosure relates to a hydrostatic traction drive with a pressure cutoff, and to a method for calibrating the pressure cutoff.

### BACKGROUND

A hydrostatic traction drive of the generic type has a hydraulic pump and a hydraulic motor which can be supplied with pressure medium by the latter in an, in particular, closed hydraulic circuit. According to the data sheet RG-E 92003 by the applicant, an axial-piston variable displacement pump of a swash plate design is known whose pressure, which it makes available to the hydraulic circuit, is directly controllable. In this context, the hydraulic pump is physically configured in such a way that the pressure always counteracts an actuation pressure on an actuation cylinder acting on the swept volume of the hydraulic pump. The hydraulic pump therefore has, for reasons of its design, an internal control loop, as a result of which the pressure always acts in the direction of its own reduction. In this context, in the pump mode the hydraulic pump is effective in the direction of reducing and in the motor mode is effective in the direction of increasing the swept volume. One chamber of the actuation cylinder is assigned to the traction mode and another counter-acting chamber is assigned to the towing mode or braking mode of the traction drive. By measuring the hydraulic pump with respect to its parameters of pressure, actuation pressure, expulsion volume and rotational speed, a characteristic diagram of the hydraulic pump is known from which a necessary actuation pressure can be determined in accordance with an accelerator pedal request or driver's request. This is carried out by means of an electronic control unit. This control of the hydraulic pump makes it possible to assign a drive torque directly to a position of the accelerator pedal, which is perceived by the operator as control of the traction drive which is very direct and therefore can be calculated well.

In order to protect the pressure-conducting or high pressure-conducting working lines, pressure-limiting valves are provided which release pressure medium from the respective working line starting from a set limiting value. However, since this is disadvantageous in terms of energy, what is referred to as a pressure cutoff is provided approximately 30 bar below the pressure which is set at the pressure-limiting valve. The pressure cutoff is implemented in such a way that a separate pressure-limiting valve with smaller dimensions is provided, to which pressure-limiting valve the highest of the pressures of the working line is applied in the opening direction and the setpoint value is applied in the closing direction. If the working pressure reaches the setpoint value or cutoff value, a control pressure line, in which control pressure medium is made available at a pressure of approximately 30 bar, is relieved via this pressure-limiting valve. Since an actuation pressure of the respective chamber is reduced via pressure-reducing valves from the control pressure medium which is made available, in this way the maximum actuation pressure which can be made available also drops. Correspondingly, in the pump mode the expulsion volume of the hydraulic pump fluctuates back owing to a relatively low actuation pressure, as a result of which the pressure or working pressure is limited by the relatively small delivery volume of the hydraulic pump. This conventional limitation or pressure cutoff is therefore based on a hydromechanical closed-loop control circuit with the specified pressure-limiting valve as a hydromechanical controller.

The comparatively high level of expenditure in terms of equipment for determining the highest of the pressures of the working lines, the provision of the pressure-limiting valve for the pressure cutoff and the energetic loss as a result of the discharging of the control pressure medium prove disadvantageous with this solution. In addition, the specified combination of a hydraulic pump which can be adjusted in an electronically open-loop controlled fashion with a pressure cutoff which can be closed-loop controlled hydromechanically can be difficult or impossible to control in transients.

In an alternative case of a pressure cutoff which is electronically closed-loop controlled and is based on pressure values which are detected by pressure sensors, said cutoff proves to be susceptible to oscillation and to be complex. This type of pressure cutoff additionally proves to have low performance since it reacts undesirably to pressure peaks and therefore brings about an engagement of the pressure cutoff and therefore a reduction in the actuation pressure and in the pump volume even in uncritical operating conditions. This can give rise to oscillations. If, in addition, for example the pressure sensor system fails, the pressure cutoff also fails, which brings about an energetic disadvantage at the latest when a pressure-limiting function responds.

Generally, the pressure sensor system must therefore satisfy stringent requirements in terms of accuracy and robustness, which gives rise to high costs.

### SUMMARY

In contrast, the disclosure is based on the object of providing a hydrostatic traction drive with a pressure cutoff with a more stable behaviour and simpler calibration, as well as a method for calibrating this pressure cutoff.

The first object is achieved by means of a hydrostatic traction drive having the features described herein, and the second by means of a method having the features described herein.

A hydrostatic traction drive has a hydraulic pump which can be coupled to a drive machine. A hydraulic motor, which can be coupled to an output, of the traction drive can be supplied with pressure medium via the hydraulic pump. The drive machine, for example a diesel engine or electric motor and/or the output can be components of the traction drive. The hydraulic pump is configured with an adjustable expulsion volume or swept volume, wherein for its adjustment an actuation cylinder with at least one cylinder space is provided. The actuation cylinder, in particular the piston thereof, can or is preferably coupled to an actuation element of the hydraulic pump, the swept volume depending on the position of said actuation element. In order to apply an actuation pressure which has an adjusting effect on the swept volume to the at least one cylinder space, at least one electrically actuable pressure valve, in particular pressure-regulating or pressure-reducing valve is provided and is assigned to the cylinder space. In order to limit a pressure of the hydraulic pump so that said pressure does not exceed, for example, an upper limit, the traction drive has a device which can influence the actuation pressure. As a result, the influencing of the actuation pressure, in particular by means of its influence on the swept volume, the limitation of the pressure is brought about. In contrast to the pressure limitation in which the pressure is limited by discharging the pressure medium via the pressure-limiting valve which opens at a set pressure limit, this pressure limitation by influencing the swept volume is referred to as a pressure cutoff. According to the disclosure, the device is configured in such a way that by means of said device the actuation pressure, and as a result the pressure, can be limited in a controlled fashion, in particular under control in a model-based fashion, and this controlled limitation can be calibrated by means of said device.

Compared with conventional solutions which are based on regulating the pressure at its limit and according to which the pressure has to be sensed and determined and the actuation pressure is influenced as a result in such a way that the limit is not exceeded, the disclosed solution of the pressure cutoff which is based on control has multiple advantages. It has a lower limit of complexity and more stable behaviour, since susceptibility to oscillation, such as, for example, in the case of regulated pressure cutoff based on pressure sensors is lower or even eliminated. A conventional solution in which the device is configured as a hydromechanical regulator, for example as a pressure-limiting valve to which pressure is applied and at the response of which a control pressure which is made available and from which the actuation pressure is reduced via the pressure valve drops, can be susceptible to transients, which are only difficult or even impossible to control, at transitions from this hydromechanical regulation of the pressure cutoff to the electronic actuation of the pressure valve, that is to say to the electronic pump control. In this case, uncontrolled increase of the swept volume of the hydraulic pump can occur. With the pressure cutoff which controls according to the disclosure this problem is, however, eliminated. In addition, it is possible, for example, to dispense with pressure sensing for the purpose of regulation, as a result of which the hydrostatic traction drive can be configured to be less complex and more cost-effective in terms of equipment. The calibration by means of the device which is embodied in this way, in particular if it is configured in such a way that the calibration can take place in an automated fashion, additionally exhibits a high level of precision of the pressure control. In addition, in this way it is possible for changes in the hydraulic pump which occur, in particular, over its service life to be newly compensated at each calibration.

Since the calibration can therefore be carried out by the device of the hydraulic pump which is present in any case—that is to say in principle with on-board means—the calibration can be carried out during maintenance in the field and there is no need for manual adjustment or return to the factory.

In one development, the hydraulic pump is constructed or configured in such a way that the pressure counteracts the actuation pressure which has an adjusting effect. The pressure always acts here in the direction of its own reduction, as a result of which the hydraulic pump has an internal regulating effect.

In one development, the swept volume of the hydraulic pump can be adjusted on both sides of a zero volume or of a neutral position by means of the actuation cylinder.

In one development, the device is configured in such a way that by means of said device the swept volume of the hydraulic pump or a variable on which the swept volume is based—for example a pivoting angle of a swash plate in the case of the hydraulic pump which is configured as an axial-piston machine of swash plate design—can be determined, in particular calculated, by balancing the pressure medium volume flow.

If the hydraulic motor is configured by the constant swept volume, the current swept volume which is necessary for the balancing is the rated swept volume and is therefore always known. The rated swept volume is preferably stored in the device, for example the purpose of balancing.

A method according to the disclosure for calibrating a device preceding a traction drive which is configured according to at least one aspect of the preceding description has steps of actuating the pressure valve with an actuation current according to a step-shaped or continuous ramp function, sensing the pressure as a function of the actuation current, determining the actuation current which is assigned to a limit of the pressure or a cutoff pressure if the pressure reaches the limit, and storing the limit and the assigned actuation current and as a result calibrating the cutoff. In this way, automatic adjustment of the behaviour of the hydraulic pump in the traction mode is provided, said adjustment ensuring a high level of precision of the pressure control.

The calibration or the adjustment preferably takes place in the stationary state of the traction drive.

In one development, the calibration can be initialized by a driver or operator. Alternatively or additionally, the calibration can be initialized by a control device of the traction drive or by the device, in particular when a predetermined event of the traction drive is sensed.

In one possible refinement of the method, the limit is firstly predefined explicitly in that it is explicitly stored in the device at the beginning. Then, by means of the sensing of the pressure as mentioned above it is possible to directly sense the reaching of the limit, and the actuation current which is then effective can be assigned to the calibration and stored.

Alternatively or additionally, the step of determining the actuation current which is assigned to the limit or the cutoff pressure is carried out as a function of a determined characteristic pressure value of the traction drive and a pressure interval thereof. As a result, the calibration can take place relative to the characteristic pressure value, in particular an opening pressure of a pressure-limiting valve.

In one further development, the method therefore has steps of implicitly specifying the limit as a pressure offset of an, in particular, steady-state opening pressure of a pressure-limiting valve of the traction drive, determining the opening pressure from a profile of the sensed pressure (in particular from a chronological profile, in particular from a chronological gradient of the sensed pressure and a valve characteristic), determining the limit from the opening pressure and the pressure offset, and actuating the pressure valve with the actuation current according to a falling ramp function up to the limit, in particular starting from the opening pressure. As a result, the calibration is carried out in such a way that it takes place relative to the opening pressure of the pressure-limiting valve and therefore utilization of the available pressure is at a maximum. The setting of the pressure-limiting valve can also be measured in the course thereof. A comparison of the opening pressure and the set value then supplies information about a possibly necessary correction of the setting or maintenance of the pressure-limiting valve.

In one development, the step of determining the opening pressure from the profile of the sensed pressure comprises steps of determining an opening of the pressure-limiting valve from the profile of the sensed pressure and maintaining the actuation current which is effective during opening, during a time period in which the pressure stabilizes at the opening pressure. The time period is known here, in particular, from a valve characteristic, stored in the control unit, of the pressure-limiting valve.

The specified limit can be, for example, the maximum permissible pressure which has already been mentioned or a maximum necessary pressure, for example as a starting point of the traction drive at which the latter overcomes the traction resistances and begins to move.

It basically advantageous to carry out the calibration under defined conditions. For this purpose, one development of the method has a preceding step of establishing at least one calibration condition. This is, for example the reaching and maintaining of a rotational speed, relevant in the traction drive, of the hydraulic pump (or of the drive machine thereof) and/or that a shaft power of the hydraulic motor is equal to zero. The last-mentioned calibration condition is also referred to as blocking condition since the hydraulic pump delivers counter to a hydraulic motor which cannot output any shaft power. This is achieved by means a parking brake and/or by means of a zero stroke volume of the hydraulic motor.

The calibration which is determined under a blocking condition, from the reference values of the limit and an assigned actuation current, can be used in one development to tolerances of the hydraulic pump outside the blocking condition, in particular at a maximum power point of the hydraulic pump with a maximum stroke volume and rated pressure. The rated pressure is here the pressure which is provided under normal conditions, far below the limit, for example approximately 200 bar.

It is also possible to determine a hysteresis of the pressure cutoff by means of the calibration according to the disclosure and to determine therefrom a correction factor or an offset.

The method can preferably be carried out for a forward driving mode and/or a reverse driving mode.

Apart from the calibration, the method has in one development steps for the controlled limitation of the pressure by influencing, in particular controlling, the at least an actuation pressure by means of the device.

In one development, the method has a step or steps of determining a traction mode or braking mode of the traction drive and/or determining a travel direction of the traction drive and/or selecting a characteristic curve and/or characteristic diagram of the hydraulic pump and/or of the pressure valve as a function of the determined mode and/or of the determined travel direction, by means of the device.

In one development, the method has a step determining the maximum permissible actuation pressure from a characteristic curve of the hydraulic pump in which the actuation pressure is described as a function of a limit of the pressure and at least as a function of the stroke volume of the hydraulic pump or of a variable, representing this swept volume, of the hydraulic pump, by means of the device.

In one development, the method has the step of determining a necessary actuation pressure according to a speed request from a characteristic diagram of the hydraulic pump in which the actuation pressure is described as a function of the pressure and at least as a function of a swept volume of the hydraulic pump or of a variable, representing this swept volume, of the hydraulic pump, by means of the device.

In one development, the method has steps of determining a relatively small necessary actuation pressure and a maximum permissible actuation pressure, determining an electrical actuation current of the pressure valve from a valve characteristic diagram of the pressure valve in which the electrical actuation current is described as a function of the actuation pressure, according to the determined lower pressure of the actuation pressures, and actuating the pressure valve with this actuation current, by means of the device.

The specified steps preferably apply to the pump mode of the hydraulic pump. In the motor mode thereof, the method has, in one development, the same steps with respect to the second actuation pressure for acting on the second cylinder chamber.

In a further development of the traction drive and/or of the method, a variable specification of the pressure and/or of the limit is provided, so that a torque of the hydraulic pump and/or a power level of the hydraulic pump can be controlled as a function of factors, such as for example the velocity, temperature or the like.

In the motor mode of the hydraulic pump pressure-limiting valves can be prevented from responding in the case of reversal over the pressure cutoff according to the disclosure.

The pressure cutoff according to the disclosure permits a braking pressure to be controlled during reversal and deceleration.

In one development, it is possible to adjust the electronic control according to the disclosure with the real pump physics: it is therefore possible, for example, to set the hydraulic pump on a test bench under defined conditions, and necessary actuation signals or actuation currents can be determined at the test bench under defined conditions and transferred as a parameter to the control unit—particular to the software thereof—, and automatic adjustment of the parameters can take place in the control unit, in the form of a calibration function.

The control according to the disclosure can be transferred, in particular in terms of equipment and in terms of a method, easily to a wide variety of designs and rated variables of hydraulic pumps.

The steps preferably take place in an automated fashion, in particular under the control of the device.

### BRIEF DESCRIPTION OF THE DRAWINGS

An exemplary embodiment of a hydrostatic traction drive according to the disclosure and an exemplary embodiment of a method according to the disclosure for calibrating the pressure cutoff thereof are illustrated in the drawings. The disclosure will now be explained in more detail with reference to the figures of these drawings, in which:

FIG. 1 shows a hydraulic circuit diagram of a hydrostatic traction drive according to an exemplary embodiment,

FIG. 2 shows a theoretical time diagram of a pressure and of an actuation current according to a calibration method, according to an exemplary embodiment, and

FIG. 3 shows a measured time diagram of a drive rotational speed, of the pressure and of the actuation current, according to the method according to FIG. 2.

### DETAILED DESCRIPTION

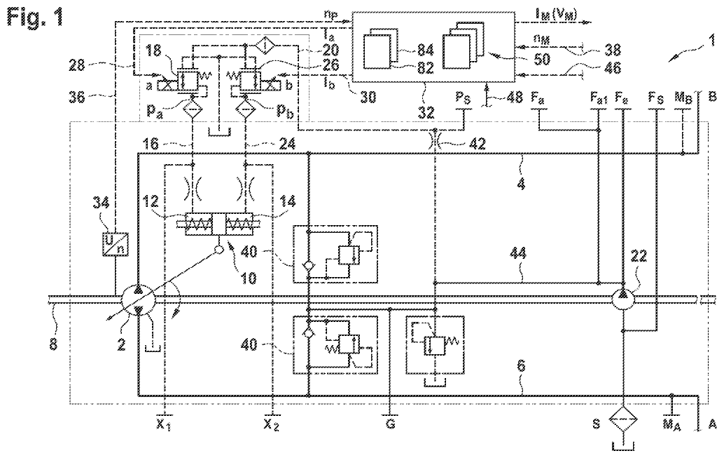

According to FIG. 1, a hydrostatic traction drive 1 has a hydraulic pump 2 which is fluidically connected in the closed hydraulic circuit via the working lines 4 and 6 to a hydraulic motor (not illustrated) in order to supply the latter with pressure medium. In this context, the hydraulic pump 2 is coupled to a drive machine (not illustrated) via a drive shaft 8 in order to transmit a torque. The coupling is not stepped up here so that the rotational speed of the drive machine and of the hydraulic pump 2 are identical. The hydraulic pump 2 is configured as an axial-piston pump of a swash plate design and can be operated in both rotational directions and both in the pump mode and in the motor mode. It has an adjustable expulsion volume V_{P} and an adjustment device 10 which is configured as a double-acting hydraulic cylinder. The hydraulic cylinder 10 has a first cylinder chamber 12 and a second cylinder chamber 14 which counteracts the first. The first cylinder chamber 12 is connected via a first actuation pressure line 16 to an output of a first pressure-reducing valve 18. The latter is connected to a control pressure line 20 which can be supplied with control pressure medium via a control pressure port p_{S} and via a feed pump 22 which is seated on the same drive shaft 8 as the hydraulic pump 2. In the same way, the second cylinder chamber 14 is connected via a second actuation pressure line 24 to a second pressure-reducing valve 26 which is connected to the control pressure line 20. The pressure-reducing valves 18, 26 can be actuated electromagnetically, wherein the actuation pressure pₐ or p_{b} which respectively results in the actuation pressure line 16 or 24 is proportional, according to a valve characteristic curve, with an actuation current Iₐ or I_{b} of the electromagnet a or b, respectively. By means of the electromagnetic activation of the pressure-reducing valves 18, 26 it is therefore possible to control the actuation pressures pₐ, p_{b} of the cylinder chambers 12, 14 by specifying the actuation currents Iₐ, I_{b}. For this purpose, the electromagnets a, b of the pressure-reducing valves 18, 26 have a signal-transmitting connection to an electronic control unit 32 via a respective signal line 28 or 30.

Furthermore, the hydrostatic traction drive 1 has a rotational-speed-sensing unit 34 via which a rotational speed n_{P} of the hydraulic pump 2 can be sensed and can be transmitted to the electronic control unit 32 via a signal line 36. Likewise, the traction drive 1 has a rotational-speed-sensing unit (not illustrated) via which the rotational speed n_{M} of the hydraulic motor can be sensed and can be transferred to the electronic control unit 32 via the signal line 38.

In order to provide safety-relevant pressure protection of the working lines 4, 6 against overloading, the hydrostatic traction drive 1 has in each case a pressure-limiting valve 40 which is connected to the respective working line 4, 6. The two pressure-limiting valves 40 are connected by their outputs to a feed pressure 44 which is connected to the feed pump 22. The feed pressure line 44 is fluidically connected via a throttle 42 to the control pressure line 20. In the case of the pressure-limiting valves responding, pressure medium is therefore relaxed into the feed pressure line 44, as a result of which energetic losses are less than if the relaxation took place toward the tank T. The pressure-limiting valves 40 each have a feed function or suction function in the form of a non-return valve.

The hydrostatic traction drive 1 can be operated both in the traction mode and in the towing mode or braking mode. In the traction mode, the hydraulic pump 2 operates in the pump mode, and in the braking mode it operates in the motor mode. In addition, the hydraulic pump 2 is reversible, that is to say its expulsion volume V_{P} can be adjusted by means of the adjustment device 10 on both sides of a neutral position with a zero volume V_{P}=0. As a result, given a constant rotational direction of the drive shaft 8 and of the drive machine (diesel engine) a reversal of the direction of travel is possible.

The electronic control unit 32 is connected via a signal line 46 to an operator interface in the form of an accelerator pedal (not illustrated). In this context, a speed request is transferred to the electronic control unit 32 from a driver via the accelerator pedal. Said speed request can relate both to reverse travel and to forward travel. If the accelerator pedal is activated, this therefore corresponds to the traction mode or pump mode of the hydraulic pump 2, and if the accelerator pedal is, on the other hand, released this corresponds to the braking mode or motor mode of the hydraulic pump 2. The activation of a travel brake (not illustrated) also corresponds to the braking mode or motor mode of the hydraulic pump 2. The control unit is configured in such a way that it can determine the corresponding mode by reference to the specified action. In order to select a travel direction, the hydrostatic traction drive 1 has in addition a travel direction switch (not illustrated) which can be actuated and which has a signal-transmitting connection to the electronic control unit 32 via a signal line 48. Depending on its position, the actuation of the hydraulic pump 2 takes place in a reversed or non-reversed adjustment range, that is to say on one or the other side of the neutral position of the swept volume of the hydraulic pump 2. For further consideration of this, reference is made to the following travel states:

Forward travel, traction mode: application of the first actuation pressure pₐ to the first cylinder chamber 12 via the first actuation pressure line 16 and the first pressure-reducing valve 18 by actuating the first pressure-reducing valve 18 with the actuation current Iₐ via the control unit 32 via the first signal line 28.

Forward travel, braking mode: application of the second actuation pressure p_{b} to the second cylinder chamber 14 via the second actuation pressure line 24 and the second pressure-reducing valve 26 by actuating the second pressure-reducing valve 26 with the actuation current I_{b} via the control unit 32 via the signal line 30.

Reverse travel, traction mode: application of pressure to the second cylinder chamber 14 via the chain 24, 26, 30, 32.

Reverse travel, braking mode: application of pressure to the first cylinder chamber 12 via the chain 16, 18, 28, 32.

In the illustrated exemplary embodiment of the hydrostatic traction drive 1, the hydraulic pump 2 is configured in such a way that the pressure p which is present in that line of the working lines 4, 6 which conducts high pressure and which counteracts the actuation pressure pₐ or p_{b} which is then effective and is effective in the direction of its own reduction. For this purpose, the hydraulic pump 2 has a structurally implemented control loop. In the present case, the hydraulic pump 2 which is configured as an axial-piston pump of a swash plate design is implemented in such a way that a control disc of the hydraulic pump 2 is arranged twisted with respect to a rotational axis of its cylinder drum. Junctions of the same cylinder which are connected to the pressure nodule control disc having the pressure (high pressure) are as a result arranged in an asymmetrically distributed fashion with respect to a pivoting axis of the swash plate. The end sections, supported on the swash plate, of the working pistons which are guided in the cylinders are also then arranged in an asymmetrically distributed fashion. A torque which swings back in the pump mode and swings out in the motor mode results from the supporting forces, therefore acting asymmetrically, of the working pistons on the swash plate. As a consequence, a relationship in the form of a pump characteristic curve or a characteristic diagram of pump characteristic curves of the hydraulic pump 2 is produced in which the respective actuation pressure pₐ, p_{b} can be described as a function of the pressure p and of the swept volume V_{P} of the hydraulic pump 2 as well as the rotational speed n_{P} thereof. These characteristic curves or characteristic diagrams are measured and are stored in the electronic control unit 32 for processing, in particular for executing, the method which will be described later.

There follows the description of a normal driving mode of the hydrostatic traction drive 1. The starting point of the description will be taken to be a non-activated accelerator pedal and a drive machine which rotates in the idling mode at the idling speed. Therefore, initially activation of accelerator pedal occurs by the operator, as a result of which the rotational speed of the drive machine (diesel) is increased from the idling mode to the rated rotational speed. Accordingly, an actuation signal or actuation current Iₐ for the hydraulic pump 2, to be more precise for the first pressure-reducing valve 18 thereof is issued by means of the electronic control unit 32 as a function of the rotational speed of the diesel engine. When the rated rotational speed of the drive machine is reached, a maximum velocity of the traction drive 1 is obtained. Accordingly, the first actuation pressure pₐ is increased in accordance with a characteristic diagram, stored in the electronic control unit 32, of the hydraulic pump 2. Since there is still no load acting, the hydraulic pump 2 swings completely out to its maximum swept volume V_{Pmax} and supplies its maximum volume flow Qₘₐₓ in the case of a rated rotational speed.

As a result of driving resistances which occur, a pressure or load pressure p, for example of 250 bar, occurs when driving on the flat. An operating point which lies on a curve of maximum power P_{nomeng} of the drive machine is then reached. At this operating point, the first actuation pressure pₐ at the rated rotational speed is dimensioned in such a way that the hydraulic power PQₘₐₓ of the hydraulic pump 2 corresponds to the rated power P_{nomeng}.

If the load on the traction drive 1 then increases, for example during uphill travel or when a wheel loader is taking on grit, the pressure p increases. Owing to the abovementioned configuration of the hydraulic pump 2, in which during forward travel in the traction mode of the hydraulic pump 2 the working pressure p counteracts the first actuation pressure pₐ in the direction of a reduction in the swept volume V_{P}, the pressure p swings back the adjustable cradle of the hydraulic pump 2, as a result of which the travel slows down. The first actuation pressure pₐ is not changed during this time, as a result of which there is a subsequent further reduction in the swept volume V_{P} when the pressure p is increased further or when there is a pressure difference Δp.

When a maximum permissible pressure pₘₐₓ or cutoff pressure or a maximum permissible pressure difference Δpₘₐₓ is reached, the electronic control unit 32 ensures that this limit pₘₐₓ, Δpₘₐₓ is not exceeded. Accordingly, despite a further increasing load, there is no further increase in the pressure p since the first actuation pressure pₐ is decreased by means of the control unit 32 via the pressure-reducing valve 18 according to FIG. 1 in such a way that the pressure pₘₐₓ is not exceeded. Therefore, if, for example, a maximum permissible pressure pₘₐₓ of, for example, 450 bar is set in the control unit 32, the control unit 32 engages according to the pressure cutoff which controls according to the disclosure and reduces the first actuation pressure pₐ. As a result, even when the load increases further the maximum permissible pressure pₘₐₓ can be prevented from being exceeded.

At least the following are input variables of a method according to the disclosure: a swinging angle α_{P} of the hydraulic pump 2 which is proportional to the swept volume V_{P}, the rotational speed n_{P} of which hydraulic pump 2 is equal to or proportional to the rotational speed n_{eng} of the drive machine in the exemplary embodiments, and the limit pₘₐₓ, which is to be defined or is predetermined, of the maximum permissible working pressure, that is to say what is referred to as the cutoff pressure.

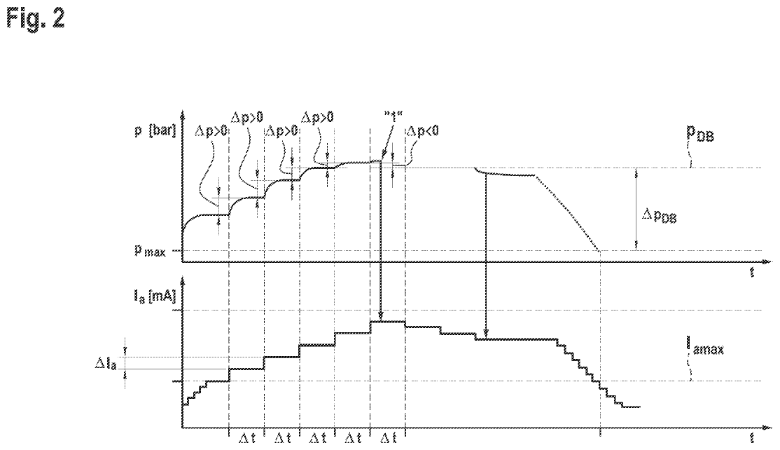

FIG. 2 shows a timing diagram of a pressure profile p(t) and actuation current profile Iₐ(t) of an exemplary embodiment of a method according to the disclosure. There are at least two exemplary embodiments of a method to be noted. Both have in common the fact that firstly calibration conditions are established. This is done, on the one hand, by a pump rotational speed n_{P} being driven or set to a value which is relevant in the driving mode. This corresponds, in particular, for example to the rated rotational speed n_{eng} of the drive machine. In addition, the hydraulic pump 2 is driven under the so-called blocking condition. This means that the hydraulic motor which is supplied with a pressure medium by said hydraulic pump 2 is set either to a displacement volume V_{N} which is equal to zero or, in the case of a hydraulic motor which is configured as a constant machine, is secured by a brake. In both cases, the shaft power of the hydraulic motor is zero and the hydraulic pump 2 generates, through its pumping power, only a leak in the hydraulic circuit.

In the next step, continuous raising of the actuation current Iₐ occurs over a ramp which is configured in a continuous or incremental fashion. In this way, the limit pₘᵢₙ or pₘₐₓ for which the assigned actuation current Iₐₘₐₓ is to be determined in the sense of a calibration is approached. At this point, the two exemplary embodiments are then divided into different branches.

According to a first exemplary embodiment of the method, the raising of the actuation current Iₐ is continued until the previously explicitly defined limit or the previously explicitly defined cutoff pressure pₘᵢₙ or pₘₐₓ is reached and sensed. The actuation current Iₐ which is then predefined at this time is then stored as a reference value for the pump control in the device 32. Tolerances of the hydraulic pump 2 and of the pressure-reducing valve 18 are then compensated with this reference value. These steps are also carried out for the traction mode during reverse travel in a way analogous to the specified steps which represent the traction mode during forward travel.

The second exemplary embodiment of the method does not adopt the approach of detecting the pressure cutoff point (explicitly predefined limit) but rather uses the function of the pressure-limiting valve 40. After the two steps of creating calibration conditions and continuously raising the pump actuation, which are identical to the first exemplary embodiment, the actuation current Iₐ is raised according to FIG. 2 until an opening of the pressure-limiting valve 40 according to FIG. 1 can be measured at the point “1”. For this purpose, by means of the control unit 32 the pressure p is sensed according to FIG. 2, top diagram, said pressure continuously increasing owing to the step-wise raising of the actuation current Iₐ according to the bottom part of FIG. 2. As long as a gradient Δp/Δt is positive, the pressure-limiting valve 40 has not yet opened. If the control unit 32 detects a negative gradient Δp/Δt, an opening point “1” of the pressure-limiting valve 40 is sensed. Starting from the opening point “1”, the pressure-limiting valve 40 exhibits a behaviour in the form of a characteristic drop in the pressure p. Beyond the opening pressure “1”, the pressure p then stabilizes according to the top part of FIG. 2 in a plateau which is sensed as an opening pressure N_{B} of the pressure-limiting valve 40 and is stored in the control unit 32.

The actuation current Iₐ subsequently drops in a step-wise fashion according to the bottom part of FIG. 2 until, starting from the opening pressure p_{DB}, the pressure p has dropped to the limit pₘₐₓ which is calculated from the pressure interval Δp_{DB}. The actuation current Iₐₘₐₓ which is then applied by the control unit 32 in FIG. 2 is stored together with the limit pₘₐₓ in the control unit 32, as a result of which tolerances of the hydraulic pump 2 and of the pressure-reducing valve are compensated.

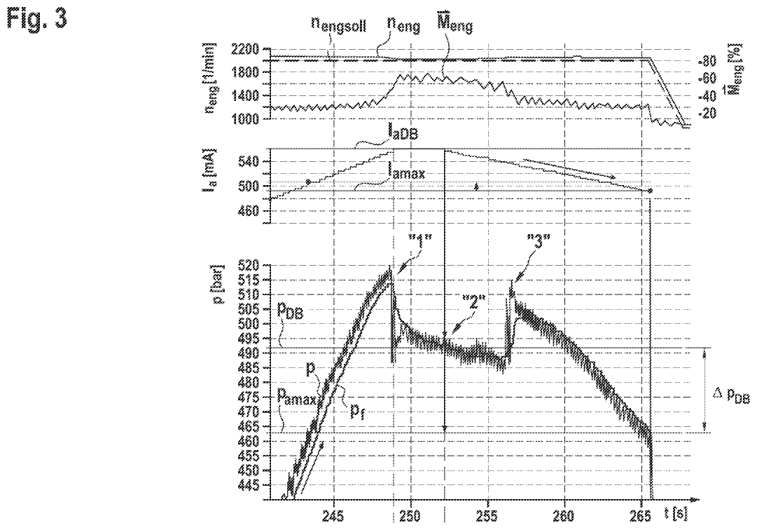

FIG. 3 shows time profiles of the actuation current Iₐ, of the pressure p, of the filtered pressure p_{f}, of the drive rotational speed n_{eng} which are measured under real conditions as set point values and actual values, as well as of the drive torque M_{eng}. The second exemplary embodiment of the method is illustrated with the detection of an opening pressure “1”, and of a pressure-limiting point “2” at which the pressure p(p_{f}) behaves in a steady-state fashion after the opening. According to the top part of FIG. 3, a setpoint rotational speed n_{engsoll} of the drive machine is predefined and set at 2000 revolutions. The actual value is n_{eng}. According to the central part of FIG. 3, the actuation current Iₐ is increased in a step-wise fashion. Accordingly, the pressure p and the filtered pressure p_{f} follow according to the bottom part of FIG. 3. At the opening point “1”, the pressure p and the filtered pressure p_{f} drop rapidly. This is sensed by the control unit 32 and detected as an opening pressure “1”. A characteristic of the pressure-limiting valve 40 is stored in the control unit 32, and the pressure profile of the pressure-limiting valve 40 is known from said characteristic as a function of the time t after the opening point “1”. The control unit 32 therefore reacts starting from the opening point “1” by keeping the actuation current Iₐ constant so that the pressure p or p_{f} can stabilize. This occurs when the gradient Δp (in particular Δp_{f})/Δt is equal to zero, which is the case in the bottom part of FIG. 3 at the so-called pressure-limiting point “2”. The pressure N_{B} and the associated current I_{aDB} are stored in the control unit 21. The limit pₐₘₐₓ can therefore be calculated directly by means of the offset or the pressure interval Δp_{DB} which has been previously stored in the control unit 32. Subsequent to the plateau of the actuation current I_{aDB}, the pressure-reducing valve 18 is actuated with an actuation current Iₐ with a step-wise dropping ramp function by means of the control unit 32. A renewed rise in the pressure when the pressure-limiting valve 40 closes is apparent. After this there is a renewed drop in the pressure p, p_{f} until the pressure p, p_{f} reaches the previously calculated limit pₐₘₐₓ. The value pair composed of pₐₘₐₓ and the assigned Tₐₘₐₓ is stored in the control unit 32. The tolerances of the hydraulic pump 2 and of the pressure-reducing valve 18 are therefore compensated.

A hydrostatic traction drive with a hydraulic pump with an adjustable swept volume is disclosed, wherein the adjustment takes place by means of an actuation pressure which is made available in proportion to actuation current, by means of which adjustment a hydraulic motor can be supplied with a pressure medium. According to the disclosure, a pressure limitation or pressure cutoff is provided on the basis of a controlled limitation of the actuation pressure as well as automated calibration of the pressure cutoff, by means of an electronic control unit of the traction drive.

Furthermore, a method for calibrating the specified pressure cutoff by means of the device is disclosed, with steps of driving along a ramp of the actuation current, sensing the pressure at the limit and sensing the assigned actuation current as well as storing this value pair in the device.

1. A hydrostatic traction drive comprising:
a hydraulic pump coupled to a drive machine and configured to supply pressure medium to a hydraulic motor, which is coupled to an output of the hydrostatic traction drive, the hydraulic pump having an actuating cylinder that includes at least one cylinder space and is configured to adjust a swept volume of the hydraulic pump;
at least one electrically actuable pressure valve configured to apply an actuation pressure which has an adjusting effect to the cylinder space; and
a device configured to limit a pressure of the hydraulic pump by influencing the actuation pressure,
wherein the device is configured so as to limit the pressure in a controlled fashion, and the controlled limitation of the pressure is calibrated.

2. The hydrostatic traction drive according to claim 1, wherein the device is an electronic control unit.

3. The hydrostatic traction drive according to claim 1, wherein the device includes a characteristic curve of the hydraulic pump, the characteristic curve representing the actuation pressure as a function of a limit of the pressure and at least of the swept volume of the hydraulic pump or of a variable for representing the swept volume of the hydraulic pump.

4. The hydrostatic traction drive according to claim 1, wherein the device includes a characteristic diagram of the hydraulic pump, in which the actuation pressure is described as a function of the pressure and at least of the swept volume of the hydraulic pump or of a variable representing the swept volume of the hydraulic pump.

5. The hydrostatic traction drive according to claim 3, wherein the actuation pressure is described in the characteristic curve as a function of a rotational speed of the hydraulic pump.

6. The hydrostatic traction drive according to claim 4, wherein the actuation pressure is described in the characteristic diagram as a function of a rotational speed of the hydraulic pump.

7. The hydrostatic traction drive according to claim 3, wherein the device is configured to determine a maximum permissible actuation pressure from the characteristic curve.

8. The hydrostatic traction drive according to claim 4, wherein the device is configured to determine from the characteristic diagram a necessary actuation pressure that is necessary according to a speed request.

9. The hydrostatic traction drive according to claim 1, wherein the device includes a valve characteristic curve of the at least one pressure valve, the valve characteristic curve describing an electrical actuation current as a function of the actuation pressure.

10. A method for calibrating a device of a traction drive that includes (i) a hydraulic pump coupled to a drive machine and configured to supply pressure medium to a hydraulic motor, which is coupled to an output of the hydrostatic traction drive, the hydraulic pump having an actuating cylinder, which includes at least one cylinder space and is configured to adjust a swept volume of the hydraulic pump, (ii) at least one electrically actuable pressure valve configured to apply an actuation pressure which has an adjusting effect to the cylinder space, and (iii) the device, which is configured to limit a pressure of the hydraulic pump by influencing the actuation pressure, wherein the device is configured so as to limit the pressure in a controlled fashion, and the controlled limitation of the pressure is calibrated, the method comprising:
actuating the pressure valve with an actuation current according to a ramp function;
sensing the pressure as a function of the actuation current;
determining a limit actuation current which is assigned to a pressure limit of the pressure if the pressure reaches the pressure limit; and
storing the pressure limit and the limit actuation current.

11. The method according to claim 10, further comprising:
explicitly specifying the pressure limit.

12. The method according to claim 10, further comprising:
implicitly specifying the pressure limit as a pressure offset of an opening pressure of a pressure-limiting valve of the traction drive;
determining the opening pressure from a profile of the sensed pressure;
determining the pressure limit from the opening pressure and the pressure offset; and
actuating the pressure valve with the actuation current according to a falling ramp function, up to the pressure limit.

13. The method according to claim 12, wherein the determining of the opening pressure from the profile of the sensed pressure comprises:
determining an opening of the pressure-limiting valve from the profile of the sensed pressure; and
maintaining an actuation current which is effective during the opening, during a time period in which the pressure stabilizes at the opening pressure.

14. The method according to claim 12, further comprising:
comparing the opening pressure with a set opening pressure which is set at the pressure-limiting valve.

15. The method according to claim 10, wherein the pressure limit is one of a maximum permissible pressure and a minimum necessary pressure of a driving mode of the traction drive.

16. The method according to claim 10, further comprising:
establishing at least one calibration condition before actuating the pressure valve with the actuation current according to the ramp function.
